(19) United States
(12) Patent Application Publication
(10) Pub. No.: US 2020/0282949 A1
(43) Pub. Date: Sep. 10, 2020

(54) SEAT BELT TAKE-UP CONTROL SYSTEM

(71) Applicant: TOYOTA JIDOSHA KABUSHIKI KAISHA, Toyota-shi (JP)

(72) Inventor: Kazuhito YAMAMOTO, Toyota-shi (JP)

(73) Assignee: TOYOTA JIDOSHA KABUSHIKI KAISHA, Toyota-shi (JP)

(21) Appl. No.: 16/738,050

(22) Filed: Jan. 9, 2020

(30) Foreign Application Priority Data
Mar. 4, 2019 (JP) 2019-038898

(51) Int. Cl. B60R 22/48; B60R 22/10; B60R 22/343; B60R 22/40; B60R 22/42

(52) U.S. Cl. CPC B60R 22/48; B60R 22/10; B60R 22/343; B60R 2022/4825; B60R 22/42; B60R 2022/4858; B60R 22/40

(57) ABSTRACT

A seat belt take-up control system includes: a first belt-take-up unit mounted at a child seat, the first belt-take-up unit taking up a seat belt of a vehicle seat and applying a predetermined tension at a time of fastening the seat belt; a belt lock unit that prevents pulling out of the seat belt in a state which the seat belt has been taken up by the first belt-take-up unit; and an second belt-take-up unit that, in a state in which pulling out of the seat belt has been locked by the belt lock unit, takes up the seat belt and applies a predetermined tension after the seat belt is fastened in at least one of a case in which pulling out of the seat belt is detected or a case in which a predetermined period of time has elapsed.

### CROSS-REFERENCE TO RELATED APPLICATION

This application claims priority under 35 USC 119 from Japanese Patent Application No. 2019-038898, filed on Mar. 4, 2019, the disclosure of which is incorporated by reference herein.

### BACKGROUND

### Technical Field

The present disclosure relates to a seat belt take-up control system.

### Related Art

Japanese Patent Application Laid-Open (JP-A) No. 2007-76536 discloses a seat belt take-up control system including a pretensioner mechanism that drives an electric motor and takes-up a webbing (seat belt) when a collision of a vehicle is predicted. Further, JP-A No. 2007-76536 describes that when an Automatic Locking Retractor (ALR) mechanism is operated, the seat belt is taken-up and a child seat (that is, a Child Restraint System (CRS)) is fixed to a vehicle seat by operation of the pretensioner mechanism.

However, JP-A No. 2007-76536 does not take into consideration the possibility of the seat belt slackening after fixing the CRS to the vehicle seat, and there is room for improvement from the viewpoint of favorably maintaining the fixed state of the CRS.

### SUMMARY

The present disclosure provides a seat belt take-up control system capable of favorably maintaining a fixed state of a CRS.

A seat belt take-up control system according to a first aspect of the present disclosure includes: a first belt-take-up unit mounted at a child seat, the first belt-take-up unit taking up a seat belt of a vehicle seat and applying a predetermined tension at a time of fastening the seat belt; a belt lock unit that prevents pulling out of the seat belt in a state in which the seat belt has been taken up by the first belt-take-up unit; and a second belt-take-up unit that, in a state in which pulling out of the seat belt is prevented by the belt lock unit, takes up the seat belt and applies a predetermined tension after the seat belt is fastened in at least one of a case in which pulling out of the seat belt is detected or a case in which a first predetermined period of time has elapsed.

In the seat belt take-up control system according to the first aspect of the present disclosure, the seat belt of the vehicle seat is taken up by the first belt-take-up unit when the child seat (i.e., a CRS) is attached, and a predetermined tension is applied to the seat belt. Further, pulling out of the seat belt is prevented by the belt lock unit. Thereby, a CRS may be efficiently fixed to the vehicle seat.

Further, the seat belt is taken up by the second belt-take-up unit, in a state in which pulling out of the seat belt is prevented by the belt lock unit, in at least one of a case in which pulling out of the seat belt is detected or a case in which a predetermined period of time has elapsed. Further, a predetermined tension is applied to the seat belt by the seat belt being taken up. As a result, it is possible to suppress the seat belt from slackening after fixing a CRS to the vehicle seat.

The seat belt take-up control system according to a second aspect of the present disclosure, in the first aspect, takes up the seat belt in a case in which a predetermined amount or more of gravitational acceleration is detected to have acted on a vehicle

In the seat belt take-up control system according to the second aspect of the present disclosure, slackening of the seat belt may be suppressed even in a case in which a predetermined amount of gravitational acceleration or more has acted on the vehicle due to sudden acceleration or deceleration during travel.

The seatbelt take-up control system according to a third aspect of the present disclosure includes, in the first aspect or the second aspect, a seating detection unit that detects that an occupant is seated in the child seat, the second belt-take-up unit being enabled in a case in which the seating detection unit detects that an occupant is seated in the child seat, and the second belt-take-up unit being disabled in a case in which the seating detection unit does not detect that an occupant is seated in the child seat.

In the seat belt take-up control system according to the third aspect of the present disclosure, when an occupant is not seated in the CRS, that is, when the CRS is not being used, the second belt-take-up unit is disabled such that power consumption may be reduced.

The seat belt take-up control system according to a fourth aspect of the present disclosure is the seat belt take-up control system according to any one of the first to third aspects, wherein the first belt-take-up unit takes up the seat belt in a case in which the seat belt has been pulled a predetermined number of times within a predetermined period of time, in a state in which a tongue plate is inserted into a buckle.

In the seat belt take-up control system according to the fourth aspect of the present disclosure, the seat belt is taken-up by pulling the seat belt a predetermined number of times. Thereby, compared with a configuration in which operation of an ALR mechanism is detected and the seat belt is taken up, the bother of operating the ALR mechanism may be eliminated. Moreover, since it is not necessary to operate switches, workability when the CRS is mounted may be improved.

According to the seatbelt take-up control system according to the present disclosure, the fixed state of the CRS may be favorably maintained.

### BRIEF DESCRIPTION OF DRAWINGS

Exemplary embodiments will be described in detail based on the following figures, wherein:

FIG. 1 is a front view of a vehicle seat equipped with a seat belt take-up control system according to an embodiment, as viewed from the front side of a vehicle;

FIG. 2 is a block diagram illustrating a hardware configuration of the seat belt take-up control system according to the embodiment;

FIG. 3 is a block diagram illustrating a hardware configuration of an ECU that configures the seat belt take-up control system according to the embodiment;

FIG. 4 is a block diagram illustrating an example of a functional configuration of the seat belt take-up control system according to the embodiment;

FIG. 5 is a flowchart illustrating a flow of the process of belt take-up at the time of fastening a seat belt in the embodiment;

FIG. 6 is a flow chart illustrating a flow of the process of belt take-up after the seat belt is fastened in the embodiment;

FIG. 7 is a flowchart illustrating a flow of the process of belt take-up after the seat belt is fastened in a first modified example of the embodiment;

FIG. 8 is a flow chart illustrating a flow the process of belt take-up after the seat belt is fastened in a second modified example of the embodiment.

### DETAILED DESCRIPTION

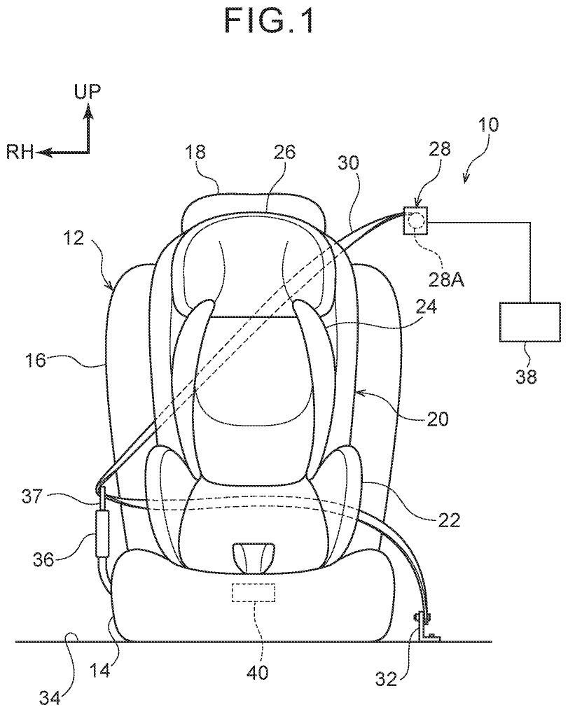

In the following, a seat belt take-up control system 10 according to an embodiment is explained with reference to the drawings. Note that arrow UP in FIG. 1 indicates the vehicle upper side, and arrow RH indicates the vehicle right-hand side. When description is given using front-rear, left-right, and vertical directions, these refer to the front-rear of the vehicle front-rear direction, the left and right of the vehicle width direction, and the vertical of the vehicle vertical direction, unless otherwise indicated.

As illustrated in FIG. 1, a vehicle seat 12, to which the seat belt take-up control system 10 according to the embodiment of the present disclosure is applied, includes a seat cushion 14, a seat back 16, and a headrest 18.

A child seat 20 (hereinafter referred to as “CRS 20” as appropriate) is mounted on the vehicle seat 12. The CRS 20 includes a seat cushion portion 22 that supports the buttocks and thighs of an occupant from a seat lower side, a seat back portion 24 that supports the back of an occupant from a seat rear side, and a head rest portion 26 that supports the head of an occupant from the seat rear side. Further, in the present embodiment, as an example, the seat front side of the CRS 20 is coincident with the seat front side of the vehicle seat 12.

Here, the CRS 20 is fixed to the vehicle seat 12 by a seat belt 30 (that is, a webbing). The seat belt 30 is formed in a long strip shape, and one end of the seat belt 30 is wound around a spool 28A that configures a retractor 28. In addition, the other end of the seat belt 30 is attached to an anchor 32 that is fixed to a floor panel 34.

The seat belt 30 is passed through a tongue plate 37, and the tongue plate 37 is provided between the retractor 28 and the anchor 32. Further, the tongue plate 37 is inserted into a buckle 36 that is provided at the vehicle seat 12, and extraction from the buckle 36 is locked.

Here, the CRS 20 includes plural belt guides that are not illustrated, and the CRS 20 is mounted on the vehicle seat 12 by the tongue plate 37 being inserted into the buckle 36 in a state in which the seat belt 30 has passed through these belt guides.

The retractor 28 is electrically connected to an Electronic Control Unit (ECU) 38, which is a control unit.

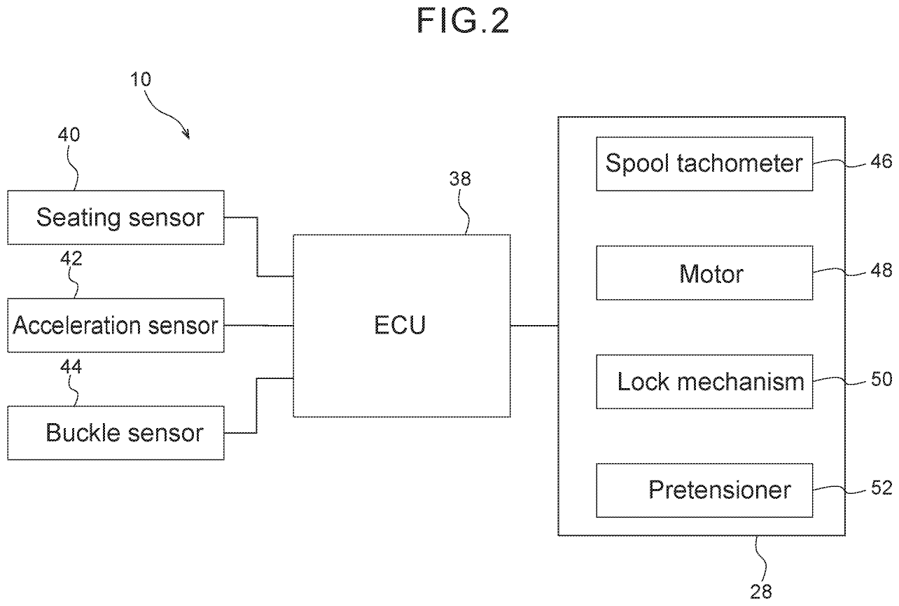

FIG. 2 is a block diagram illustrating the hardware configuration of the seat belt take-up control system 10. As illustrated in FIG. 2, the ECU 38 is electrically connected to a seating sensor 40, an acceleration sensor 42, a buckle sensor 44, and the retractor 28.

As illustrated in FIG. 1, the seating sensor 40 is provided inside the seat cushion 14 and is a sensor that detects that an occupant is seated in the vehicle seat 12.

The acceleration sensor 42 illustrated in FIG. 2 is mounted on a vehicle and detects an acceleration acting on the vehicle. For example, if sudden acceleration or deceleration occurs while the vehicle is traveling, this acceleration or deceleration is detected by the acceleration sensor.

The buckle sensor 44 is a sensor that is provided at the buckle 36 (see FIG. 1), and detects that the tongue plate 37 is inserted in the buckle 36.

The ECU 38 is electrically connected to a spool tachometer 46, a motor 48, a lock mechanism 50, and a pretensioner 52, respectively, which configure the retractor 28. The spool tachometer 46 detects rotation of the spool 28A. In the present embodiment, as an example, N-pole and S-pole magnets are alternately attached to a rotating body that is not illustrated and that rotates integrally with the spool 28A. Further, rotation of the spool 28A is detected by detecting a magnetic pole that changes with rotation of the spool 28A. Note that the present disclosure is not limited to this, and rotation of the spool 28A may be detected by another method.

The motor 48 is driven by power being supplied and the spool 28A is caused to rotate in one direction or in another direction. As a result, the seat belt 30 is taken up by the retractor 28 by driving the motor 48 and rotating the spool 28A in one direction. Further, the seat belt 30 is pulled out from the retractor 28 by the spool 28A being rotated in the other direction. Note that the motor 48 is configured to be able to switch between a connected state in which power may be transmitted to the spool 28A by a clutch gear and a non-connected state in which power is not transmitted.

The lock mechanism 50 is a mechanism that locks pulling out of the seat belt 30 by being operated. As a result, when the seat belt 30 is in a locked state due to the lock mechanism 50, the seat belt 30 cannot be pulled out from the retractor 28 even if the seat belt 30 is pulled. Note that the lock mechanism 50 may adopt, for example, a structure in which rotation of the spool 28A is mechanically locked or a structure in which rotation of the spool 28A is stopped by applying a voltage to the motor 48. In addition, as another lock mechanism, an electric lock type lock mechanism that is provided with a permanent magnet and an electromagnet may be adopted. That is, this is a system in which the core of an electromagnet repels a permanent magnet and rotation of the spool 28A is locked by energizing the coil of the electromagnet in one direction, and the core of the electromagnet attracts the permanent magnet and rotation of the spool 28A is unlocked by energizing the coil in the other direction. In the electric lock type lock mechanism, rotation of the spool 28A may be locked or unlocked at any time by energizing the coil based on a signal from each sensor.

Further, in the present embodiment, as an example, when a collision of the vehicle is predicted based on a signal from a collision prediction sensor or the like that is not illustrated, the ECU 38 drives the motor 48 and causes the spool 28A to rotate in one direction. As a result, the seat belt 30 is taken-up so as to have a predetermined tension, and the occupant may be restrained at the vehicle seat 12 before the collision.

When actuated, the pretensioner 52 rotates the spool 28A in one direction with a force that is stronger than that of the motor 48 and forcibly takes up the seat belt 30. Then, when a collision of the vehicle is detected based on a signal from a collision sensor or the like that is not illustrated, the ECU 38 operates the pretensioner 52 and the occupant is restrained at the vehicle seat 12.

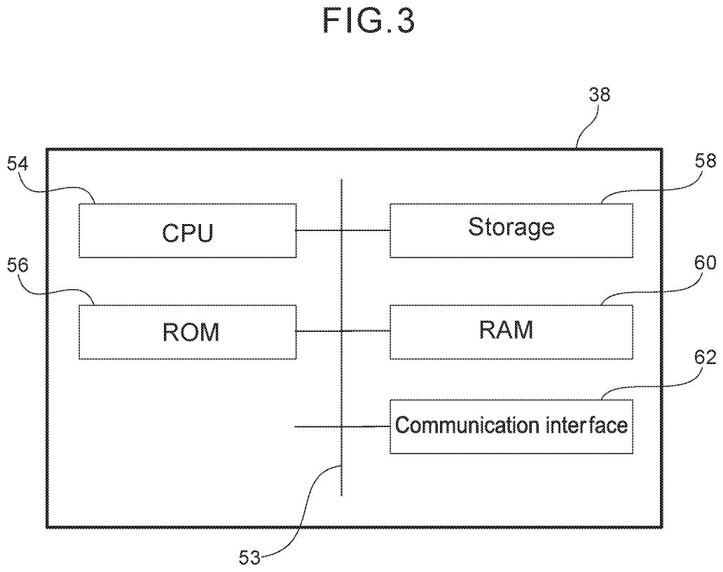

FIG. 3 is a block diagram illustrating the hardware configuration of the ECU 38 that configures the seat belt take-up control system 10. As illustrated in FIG. 3, the ECU 38 is configured to include a Central Processing Unit (CPU) 54, a Read Only Memory (ROM) 56, a Random Access Memory (RAM) 60, a storage 58, and a communication interface 62. Further, these respective components are connected via a bus 53 so as to be able to communicate with one another.

The CPU 54 is a central processing unit that executes various programs and controls the respective aforementioned components. That is, the CPU 54 reads out a program from the ROM 56 or the storage 58, and executes the program by using the RAM 60 as a work space. Further, the CPU 54 controls each of the various aforementioned configurations and performs various computation processing according to the program recorded in the ROM 56 or the storage 58.

The ROM 56 holds various programs and various data. The RAM 60 temporarily stores programs or data as a work space. The storage 58 is configured by a Hard Disk Drive (HDD) or a Solid State Drive (SSD), and holds various data and various programs including an operating system.

The communication interface 62 is an interface for the ECU 38 to communicate with various sensors, the retractor 28, and other devices, and utilizes standards such as Ethernet (registered trademark), FDDI, and Wi-Fi (registered trademark).

The seat belt take-up control system 10 of the present embodiment realizes various functions using the hardware resources illustrated in FIGS. 2 and 3. Functions realized by the seat belt take-up control system 10 are described below.

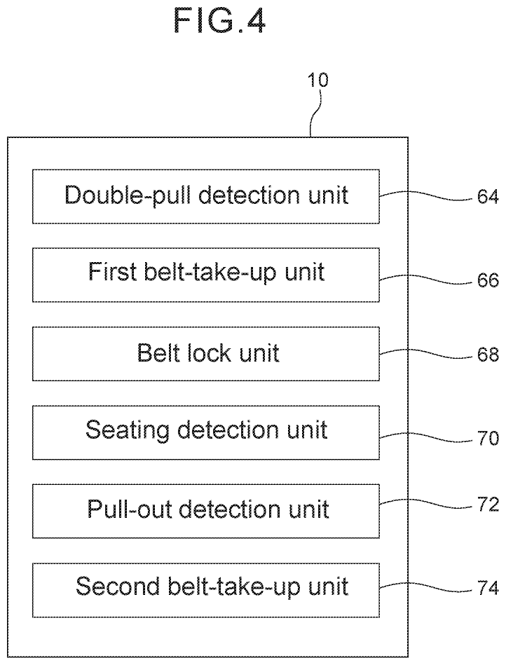

FIG. 4 is a block diagram illustrating an example of a functional configuration of the seat belt take-up control system 10.

As illustrated in FIG. 4, the seat belt take-up control system 10 has a double-pull detection unit 64, a first belt-take-up unit 66, a belt lock unit 68, a seating detection unit 70, a pull-out detection unit 72, and a second belt-take-up unit 74, as functional components. Further, these respective functional components are realized by the CPU 36 reading out and executing programs that are recorded in the ROM 56 or the storage 58.

The double-pull detection unit 64 detects that the seat belt 30 has been pulled twice in a predetermined period of time. Note that in the present embodiment, as an example, if the spool 28A is rotated in a pull-out direction based on a signal from the spool tachometer 46, it is determined that the seat belt 30 has been pulled. Further, the double-pull detection unit 64 is not limited to the case in which an occupant directly pulls the seat belt 30 twice, but detects the seat belt 30 being pulled twice in a predetermined period of time even in the case in which the CRS 20 is rocked back and forth such that the seat belt 30 is pulled twice or more.

The first belt-take-up unit 66 takes up the seat belt 30 of the vehicle seat 12, at which the CRS 20 is mounted, and applies a predetermined tension. Specifically, the seat belt 30 is taken up by driving the motor 48 of the retractor 28 and rotating the spool 28A in the take-up direction. Note that the first belt-take-up unit 66 is configured to drive the motor 48 and take up the seat belt 30 until the tension of the seat belt 30 reaches a predetermined tension.

The belt lock unit 68 operates the lock mechanism 50 of the retractor 28 to lock pulling out of the seat belt 30. Note that the seat belt 30 is configured to be able to be taken up by rotating the spool 28A in the take-up direction even in a state in which pulling-out of the seat belt 30 is prevented by the lock mechanism 50.

The seating detection unit 70 detects that an occupant is seated in the vehicle seat 12 based on a signal from the seating sensor 40. Note that in the present embodiment, as an example, the seating sensor 40 is not turned on in a state in which the CRS 20 is attached to the vehicle seat 12, and a threshold value is adjusted such that the seating sensor 40 reacts and turns on in the case in which the occupant is seated in the CRS 20.

The pull-out detection unit 72 detects that the seat belt 30 is pulled out (slackened). Specifically, in a state in which pulling-out of the seat belt 30 is prevented by the belt lock unit 68, it is determined that the seat belt 30 is pulled-out when the spool 28A has been rotated in the pull-out direction. Note that cases in which the seat belt 30 is pulled-out in a state in which pulling-out of the seat belt 30 is prevented are cases in which centrifugal forces act on the vehicle at the time of sudden acceleration or deceleration during travel, cases in which an external force is input to the vehicle from the road surface, and the like. Further, there are cases in which slackening of the seat belt 30, which is fixing the CRS 20, occurs due to the seat belt 30 being pulled out.

The second belt-take-up unit 74 takes-up the seat belt 30 and applies a predetermined tension in a state in which the CRS 20 is mounted on the vehicle seat 12. Specifically, a predetermined tension is applied to the seat belt 30 by driving the motor 48 of the retractor 28 and rotating the spool 28A in the take-up direction under predetermined conditions.

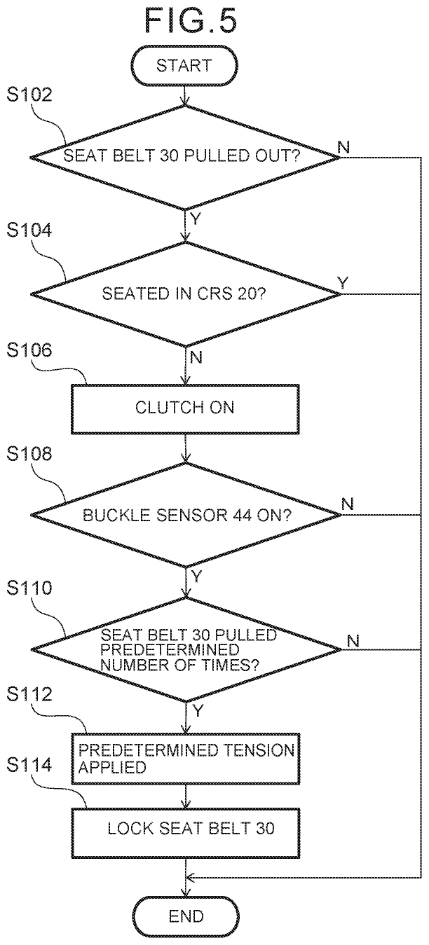

Here, the flow of the process of belt take-up at the time of fastening the seat belt by the seat belt take-up control system 10 is described with reference to the flowchart of FIG. 5. The CPU 54 reads out the program from the ROM 56 or the storage 58, outputs it to the RAM 60 and executes it, whereby the process of belt take-up at the time of fastening the seat belt is performed.

As illustrated in FIG. 5, in step S102, the CPU 54 determines whether or not the seat belt 30 has been pulled out. That is, when an occupant mounts the CRS 20 on the vehicle seat 12, the occupant pulls out only the required length of the seat belt 30, against the urging force of the spring that urges the spool 28A in the take-up direction, after the CRS 20 is placed on the vehicle seat 12. In step S102, if the seat belt 30 has been pulled out as described above, it is determined based on a signal from the spool tachometer 46 that the seat belt 30 has been pulled out.

If the CPU 54 determines in step S102 that the seat belt 30 has been pulled out, the CPU 54 proceeds to the process in step S104. Further, if the CPU 54 determines in step S102 that the seat belt 30 has not been pulled out, the CPU 54 terminates the process of belt take-up at the time of fastening the seat belt.

In step S104, the CPU 54 determines whether or not an occupant is seated in the CRS 20. Specifically, the CPU 54 determines, by the function of the seating detection unit 70 (see FIG. 4), whether or not an occupant is seated in the CRS 20 based on a signal from the seating sensor 40. If the CPU 54 determines that an occupant is seated in the CRS 20, the process of belt take-up after the seat belt is fastened is terminated. On the other hand, if it is determined that an occupant is not seated in the CRS 20, the CPU 54 proceeds to step S106. By this process, for example, the seat belt 30 is not taken up during general use such as the seat belt 30 being pulled out and put on after the occupant is seated in the vehicle seat 12.

In step S106, the CPU 54 turns on the clutch. Specifically, the CPU 54 connects the spool 28A and the motor 48 via the clutch gear by slightly rotating the motor 48 in the take-up direction. In the following description, the state in which the clutch is turned on refers to a state in which the spool 28A and the motor 48 are connected. Further, the state in which the clutch is turned off refers to a state in which the connection state between the spool 28A and the motor 48 is released. Then, the spool 28A is connected to the motor 48 by the clutch gear, whereby a resistance force of the energized motor 48 is transmitted to the spool 28A. For this reason, the seat belt 30 is not taken up by the urging force of the spring.

In step S108, the CPU 54 checks the buckle sensor 44 and determines whether or not the buckle sensor 44 is ON. That is, in step S108, when the passenger passes the seat belt 30 through the belt guides of the CRS 20 and inserts the tongue plate 37 into the buckle 36, the buckle sensor 44 is turned on and it is determined that the tongue plate 37 is inserted into the buckle 36.

If the CPU 54 determines in step S108 that the buckle sensor 44 is ON, the CPU 54 proceeds to step S110. Further, if the CPU 54 determines in step S108 that the buckle sensor 44 is not ON, that is, if the CPU 54 determines that the buckle sensor 44 is OFF, the CPU 54 terminates the process of belt take-up at the time of fastening the seat belt.

The CPU 54 determines in step S110 whether or not the seat belt 30 has been pulled only a predetermined number of times. The CPU 54 determines that the seat belt 30 has been pulled if, by the seat belt 30 being pulled, the spool 28A of the retractor 28 is rotated in the pull-out direction based on a signal from the spool tachometer 46. Then, if the seat belt 30 has been pulled, the CPU 54 starts a timer and determines whether or not the seat belt 30 is pulled a predetermined number of times within a predetermined period of time. In the present embodiment, the CPU 54 determines whether or not the seat belt 30 has been pulled twice within a predetermined period of time in step S110 by the function of the double-pull detection unit 64 (see FIG. 4).

If the CPU 54 determines in step S110 that the seat belt 30 has been pulled twice within a predetermined period of time, the CPU 54 proceeds to the process in step S112. On the other hand, if the seat belt 30 has not been pulled twice in a predetermined period of time in step S110, that is, if a predetermined period of time elapses without the seat belt 30 being pulled after starting the timer at step S108, the CPU 54 terminates the process of belt take-up at the time of fastening the seat belt.

The CPU 54 applies a predetermined tension to the seat belt 30 in step S112. Specifically, by the function of the first belt-take-up unit 66 (FIG. 4), the CPU 54 drives the motor 48 of the retractor 28 and takes up the seat belt 30 until the tension of the seat belt 30 reaches a predetermined tension. At this time, slack may be removed by the passenger shaking the CRS 20. In addition, the CRS 20 may be stably fixed to the vehicle seat 12 by the occupant leading the seat belt 30 to the retractor 28.

The CPU 54 prevents the seat belt 30 in step S114. Specifically, by the function of the belt lock unit 68 (FIG. 4), the CPU 54 operates the lock mechanism 50 of the retractor 28 and locks pulling out of the seat belt 30. Then, the CPU 54 terminates the process of belt take-up at the time of fastening the seat belt.

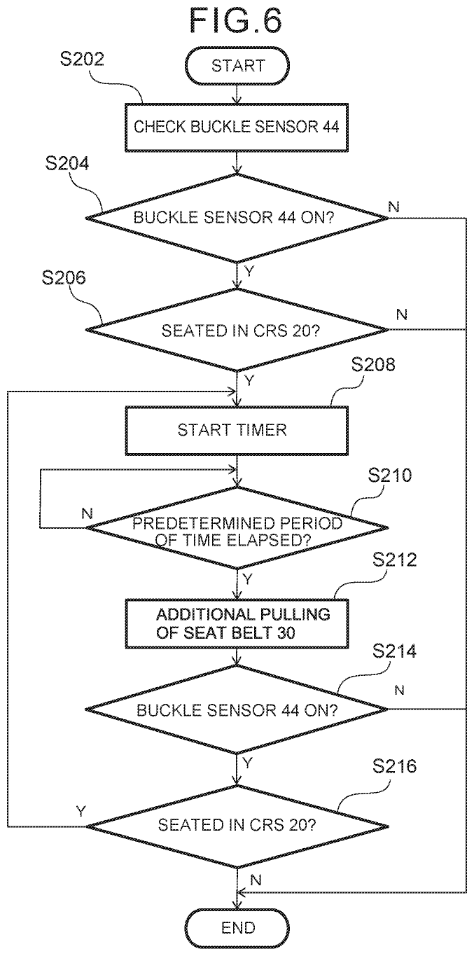

Next, the flow of the process of belt take-up after the seat belt is fastened by the seat belt take-up control system 10 is described with reference to the flowchart of FIG. 6. The CPU 54 reads out the program from the ROM 56 or the storage 58, outputs it to the RAM 60, and executes it, whereby the process of belt take-up after the seat belt is fastened is performed.

As illustrated in FIG. 6, the CPU 54 checks the buckle sensor 44 in step S202. That is, the CPU 54 checks whether the tongue plate 37 is inserted into the buckle 36. Next, in step S204, the CPU 54 determines whether or not the buckle sensor 44 is ON.

If the CPU 54 determines in step S204 that the buckle sensor 44 is ON, the CPU 54 proceeds to step S206. Further, if the CPU 54 determines in step S204 that the buckle sensor 44 is not ON, that is, if the CPU 54 determines that the buckle sensor 44 is OFF, the CPU 54 terminates the process of belt take-up after the seat belt is fastened.

In step S206, the CPU 54 determines whether or not an occupant is seated in the CRS 20. Specifically, by the function of the seating detection unit 70 (see FIG. 4), the CPU 54 determines whether or not an occupant is seated in the CRS 20 based on a signal from the seating sensor 40. If the CPU 54 determines that an occupant is seated in the CRS 20, the CPU 54 proceeds to step S208. On the other hand, if the CPU 54 determines that an occupant is not seated in the CRS 20, the process of belt take-up after the seat belt is fastened is terminated.

The CPU 54 starts a timer at step S208. That is, the CPU 54 starts the timer from the time when it is detected that the occupant is seated in the CRS 20 in a state in which the buckle sensor 44 is ON.

At step S210, the CPU 54 determines whether or not a predetermined period of time has elapsed. If it is determined in step S208 that a predetermined period of time has elapsed since the timer was started, the CPU 54 proceeds to step S212. On the other hand, if a predetermined period of time has not elapsed since the timer was started, the CPU 54 repeats the process of step S210 until a predetermined period of time elapses.

In step S212, the CPU 54 performs additional pulling of the seat belt 30. Specifically, the motor 48 of the retractor 28 is driven to cause the spool 28A to rotate in the take-up direction, thereby applying a predetermined tension to the seat belt 30 that is fixing the CRS 20.

In step S214, the CPU 54 determines whether or not the buckle sensor 44 is ON. If the CPU 54 determines that the buckle sensor 44 is ON, the CPU 54 proceeds to the process of step S216. If the CPU 54 determines that the buckle sensor 44 is not ON, that is, if it is determined that the buckle sensor 44 is OFF, the process of belt take-up after the seat belt is fastened is terminated.

In step S216, the CPU 54 determines whether or not an occupant is seated in the CRS 20. If the CPU 54 determines that an occupant is seated in the CRS 20, the CPU 54 proceeds to step S208. On the other hand, if it is determined that an occupant is not seated in the CRS 20, the process of belt take-up after the seat belt is fastened is terminated.

In this manner, the CPU 54 repeats the process of from step S208 to step S216 when the buckle sensor 44 is ON and an occupant is seated in the CRS 20.

Note that when an occupant gets off the CRS 20, it is confirmed that the occupant has left the seat based on a signal from the seating sensor 40, and it is confirmed that the tongue plate 37 has been removed from the buckle 36 based on a signal from the buckle sensor 44. Then, the CPU 54 turns off the clutch by slightly rotating the motor 48 in the pull-out direction. As a result, the seat belt 30 may be taken up by the spring.

(Operation) Next, the operation of the present embodiment will be described.

In the seat belt take-up control system 10 according to the present embodiment, the CRS 20 may be efficiently fixed to the vehicle seat 12 as described in the process of belt take-up at the time of fastening the seat belt in FIG. 5. That is, when the tongue plate 37 is inserted into the buckle 36 in a state in which the seat belt 30 has been passed through the belt guides of the CRS 20, the buckle sensor 44 is turned on (step S108). In this state, the seat belt 30 is taken up by the function of the first belt-take-up unit 66, and a predetermined tension is applied to the seat belt 30, whereby the CRS 20 may be fixed to the vehicle seat 12 (step S112). Further, pulling out of the seat belt 30 may be prevented by the belt lock unit 68 (step S114).

Further, by the function of the double-pull detection unit 64, the first belt-take-up unit 66 of the present embodiment takes up the seat belt 30 if the seat belt 30 is pulled twice within a predetermined period of time in a state in which the tongue plate 37 is inserted into the buckle 36 (step S110). Thereby, compared with a configuration in which operation of an ALR mechanism is detected and the seat belt 30 is taken up, the bother of operating the ALR mechanism may be eliminated. That is, due to a standard ALR function being activated by pulling out the entirety of the seat belt 30, the bother of an occupant pulling out the entirety of the seat belt 30 in order to fix the CRS 20 to the vehicle seat 12 occurs. In contrast, in the present embodiment, since the CRS 20 may be fixed to the vehicle seat 12 by merely pulling the seat belt 30 twice, it does not take time and effort. In addition, since it is not necessary to operate switches in order to take up the seat belt 30, workability when mounting the CRS 20 may be improved.

Further, in the present embodiment, as described in the process of belt take-up after the seat belt is fastened in FIG. 6, if an occupant is not seated in the CRS 20, that is, if the CRS 20 is not being used, the process of belt take-up after the seat belt is fastened is terminated (step S206). That is, when an occupant is not seated in the CRS 20, the second belt-take-up unit is disabled, such that power consumption may be reduced.

Furthermore, if a predetermined period of time elapses in a state in which pulling-out of the seat belt 30 is prevented by the belt lock unit 68, a predetermined tension is applied to the seat belt 30 by the seat belt 30 being taken up by the second belt-take-up unit 74. Thereby, it is possible to suppress the seat belt 30 from slackening after the CRS 20 is fixed to the vehicle seat 12. As a result, the fixed state of the CRS 20 may be maintained satisfactorily.

Further, in the present embodiment, since the CRS 20 may be mounted without requiring a complicated configuration such as an ALR mechanism, the retractor 28 may be downsized as compared with a retractor including an ALR mechanism. As a result, the retractor 28 may be attached to the vehicle seat 12, and the degree of freedom of the seat layout may be improved as compared with a configuration in which a retractor is attached to the vehicle body side.

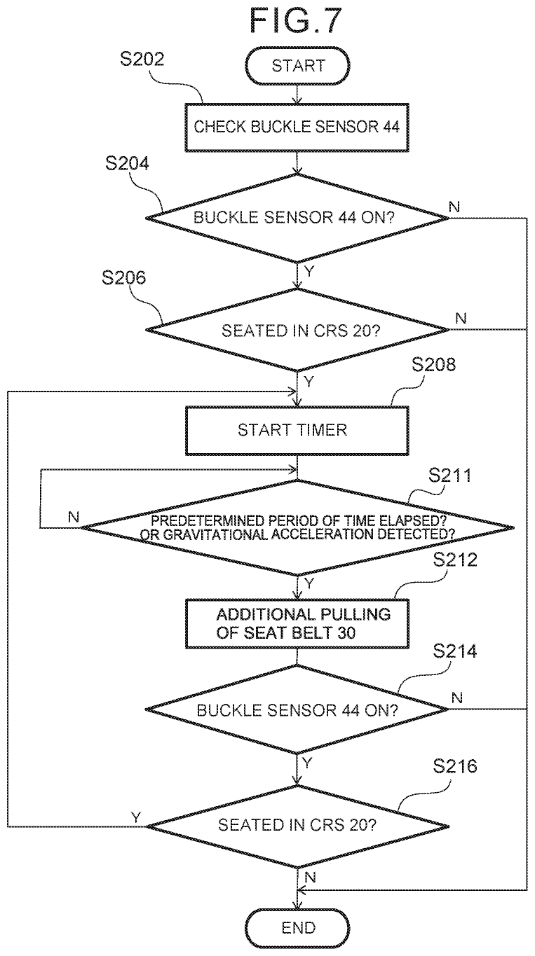

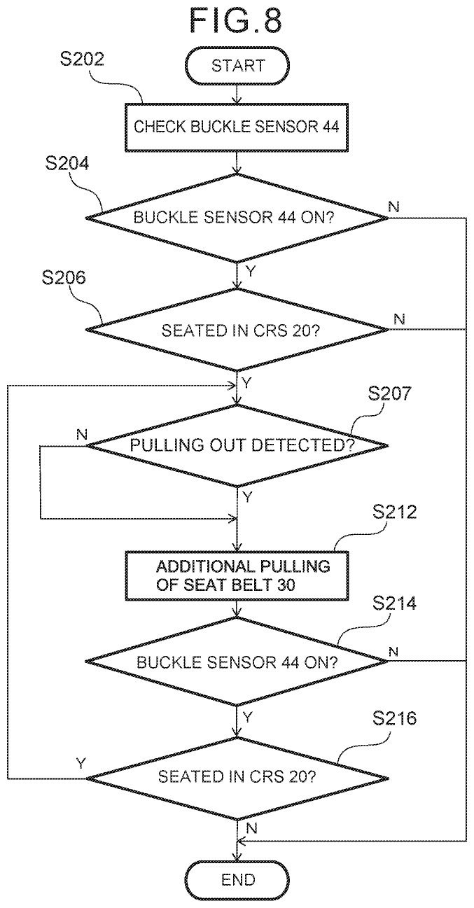

Note that in the present embodiment, the seat belt 30 is additionally pulled if a predetermined period of time has elapsed; however, the present disclosure is not limited to this. For example, the present disclosure may also be a configuration provided with the process of belt take-up after the seat belt is fastened illustrated by the flowcharts of FIG. 7 and FIG. 8.

### First Modified Example

FIG. 7 is a flowchart illustrating the flow of the process of belt take-up after the seat belt is fastened in a first modified example. The CPU 54 reads out the program from the ROM 56 or the storage 58, outputs it to the RAM 60, and executes it, whereby the process of belt take-up after the seat belt is fastened is performed.

As illustrated in FIG. 7, the processes in steps S202 to S208 and steps S212 to S216 in the present modified example are the same as the processes in FIG. 6. Further, in this modified example, the process of step S211 is performed in place of step S210 of FIG. 6.

In step S211, the CPU 54 determines whether or not a predetermined period of time has elapsed, and whether or not a predetermined amount of gravitational acceleration or more has acted. If it is determined that a predetermined period of time has elapsed since the timer was started in step S208, the CPU 54 proceeds to step S212. Further, if predetermined amount of gravitational acceleration or more is detected based on a signal from the acceleration sensor 42 (see FIG. 2) before a predetermined period of time elapses, the CPU 54 proceeds to step S212.

On the other hand, the CPU 54 repeats the process of step S211 if a predetermined period of time has not elapsed without a predetermined amount of gravitational acceleration or more in step S211 being detected.

In step S212, the CPU 54 performs additional pulling of the seat belt 30. Specifically, the motor 48 of the retractor 28 is driven to rotate the spool 28A in the take-up direction, thereby applying a predetermined tension to the seat belt 30 that is fixing the CRS 20.

As described above, in this modified example, it is possible to suppress the seat belt 30 from slacking even if a predetermined amount of gravitational acceleration or more acts on a traveling vehicle due to sudden acceleration or deceleration.

### Second Modified Example

FIG. 8 is a flowchart illustrating the flow of the process of belt take-up after the seat belt is fastened in a second modified example. The CPU 54 reads out the program from the ROM 56 or the storage 58, outputs it to the RAM 60, and executes it, whereby the process of belt take-up after the seat belt is fastened is performed.

As illustrated in FIG. 8, the processes in steps S202 to S206 and steps S212 to S216 in the present modified example are the same as the processes in FIG. 6. In the present modified example, the process of step S207 is performed in place of the processes of step S208 and step S210 of FIG. 6.

In step S207, the CPU 54 determines whether or not pulling out of the seat belt 30 is detected. Specifically, by the function of the pull-out detection unit 72 (FIG. 4), the CPU 54 determines whether or not the seat belt 30 has been pulled out (slackened). If the CPU 54 determines in step S207 that the seat belt 30 has been pulled out, the CPU 54 proceeds to the process in step S212 and performs additional pulling of the seat belt 30.

On the other hand, if the CPU 54 determines in step S207 that the seat belt 30 has not been pulled out, the CPU 54 proceeds to step S214 without going through the process of step S212. That is, in this case, the seat belt 30 is not additionally pulled.

As described above, in the present modified example, the seat belt 30 is additionally pulled only if the seat belt 30 is slackened, such that it is not necessary to frequently drive the motor 48 of the retractor 28.

Although explanation has been given regarding a seat belt take-up control system according to the present embodiment and modified examples, obviously various embodiments are possible within a range not departing from the gist of the present disclosure. For example, the above-described present embodiment and modified examples may be combined, and the process of belt take-up after the seat belt is fastened illustrated in FIG. 6 and the process of belt take-up after the seat belt is fastened illustrated in FIG. 8 may be combined. In this case, the second belt-take-up unit 74 takes up the seat belt 30 and applies a predetermined tension in at least one of the case in which pulling out of the seat belt 30 is detected or the case in which a predetermined period of time has elapsed.

Further, in addition to the process of belt take-up at the time of fastening the seat belt described in the above present embodiment and the modified example, the seat belt 30 may be additionally pulled when the ignition (or power) of the vehicle is switched from OFF to ON. Thus, even when the ignition (or power) of the vehicle is OFF and the fixed state of the CRS 20 is in an unstable state, tension may be applied to the seat belt 30 and the fixed state of the CRS 20 made stable when the ignition (or power) is turned on.

In the above-described embodiment and modified examples, if the seat belt 30 is detecting as having been pulled twice within a predetermined period of time by the double-pull detection unit 64, the seat belt 30 is taken up by the first belt-take-up unit 66 and tension is applied; however, the present disclosure is not limited to this. For example, a triple-pull detection unit may be provided in place of the double-pull detection unit 64. In this case, if the seat belt 30 is pulled three times within a predetermined period of time, the seat belt 30 is taken up by the first belt-take-up unit 66 and a predetermined tension is applied. Conversely, in place of the double-pull detection unit 64, it may be configured such that the seat belt 30 is taken up and a predetermined tension applied if the seat belt 30 is pulled once.

Furthermore, in the above-described embodiment and modified examples, the seating detection unit 70 detects that an occupant is seated in the CRS 20 based on a signal from the seating sensor 40; however, that an occupant is seated in the CRS 20 may be detected by another method. For example, an optical camera or the like that may capture an image of the vehicle interior may be installed, and the seating detection unit 70 may determine whether or not an occupant is seated in the CRS 20 based on an image captured by the optical camera.

Moreover, each process that is executed by the CPU 54 reading software (programs) in the above-described embodiment may be executed by various processors other than a CPU. Examples of such processors include Programmable Logic Devices (PLD) with circuit configurations that are reconfigurable after manufacture, such as Field-Programmable Gate Arrays (FPGA), and dedicated electronic circuits that are processors including circuit configurations custom designed to execute specific processing, such as Application Specific Integrated Circuits (ASIC) or the like. Moreover, the various processing may be executed by one type of these processors, or may be executed by a combination of two or more these processors that are of the same type or different types (for example, plural FPGAs, a combination of a CPU and an FPGA, etc.). More specific examples of hardware structures of such processors include electric circuits configured by combining circuit elements such as semiconductor devices.

In the above-described embodiment, each program is described as being stored (installed) in a computer-readable non-transitory recording medium in advance. However, the present disclosure is not limited to this, and each program may be provided in a format of being recorded in a non-temporary recording medium such as Compact Disc Read Only Memory (CD-ROM), a Digital Versatile Disc Read Only Memory (DVD-ROM), and a Universal Serial Bus (USB) memory. Moreover, each program may be provided in a format to be downloaded from an external device over a network.

What is claimed is:

1. A seat belt take-up control system, comprising:
a first belt-take-up unit mounted at a child seat, the first belt-take-up unit taking up a seat belt of a vehicle seat and applying a predetermined tension at a time of fastening the seat belt;
a belt lock unit that prevents pulling out of the seat belt in a state in which the seat belt has been taken up by the first belt-take-up unit; and
a second belt-take-up unit that, in a state in which pulling out of the seat belt is prevented by the belt lock unit, takes up the seat belt and applies a predetermined tension after the seat belt is fastened in at least one of a case in which pulling out of the seat belt is detected or a case in which a first predetermined period of time has elapsed.

2. The seat belt take-up control system recited in claim 1, wherein the seat belt is taken up in a case in which a predetermined amount or more of gravitational acceleration or more is detected to have acted on a vehicle.

3. The seat belt take-up control system recited in claim 1, further comprising a seating detection unit that detects that an occupant is seated in the child seat, the second belt-take-up unit being enabled in a case in which the seating detection unit detects that the occupant is seated in the child seat, and the second belt-take-up unit being disabled in a case in which the seating detection unit does not detect that an occupant is seated in the child seat.

4. The seat belt take-up control system recited in claim 1, wherein the first belt-take-up unit takes up the seat belt in a case in which the seat belt has been pulled a predetermined number of times within a second predetermined period of time, in a state in which a tongue plate is inserted into a buckle.

5. The seat belt take-up control system recited in claim 1, wherein a seating sensor that detects that an occupant is seated in the vehicle seat is provided inside a seat cushion, the seating sensor not being turned on in a state in which the child seat is attached to the vehicle seat, and a threshold value being adjusted such that the seating sensor turns on in a case in which the occupant is seated in the child seat.
